(19) United States
(12) Patent Application Publication
(10) Pub. No.: US 2009/0095135 A1
(43) Pub. Date: Apr. 16, 2009

(54) Seal breaking device

(76) Inventor: Leon Avanesian, Lacrescenta, CA (US)

Correspondence Address: JAMES RAY & ASSOCIATES, 2640 PITCAIRN ROAD, MONROEVILLE, PA, 15146, US

(21) Appl. No.: 12/287,331

(22) Filed: Oct. 8, 2008

Related U.S. Application Data
(60) Provisional application No. 60/979,627, filed on Oct. 12, 2007.

(51) Int. Cl. B67B 7/16

(52) U.S. Cl. 81/3.55

(57) ABSTRACT

A seal breaking device is provided. Such seal breaking device includes an elongated handle member having a first end and a second end. Such elongated handle member is manufactured from a first predetermined material and has a first predetermined size and a first predetermined shape. A lid lifting member is operably connected at a first end thereof to such first end of such elongated handle. Such lid lifting member is manufactured from a second predetermined material and has a second predetermined size and a second predetermined shape.

### CROSS REFERENCE TO RELATED APPLICATION

This patent application is related to and claims priority from U.S. Provisional Patent Application Ser. No. 60/979,627 filed Oct. 12, 2007.

### FIELD OF THE INVENTION

The present invention relates, in general, to jar openers and, more particularly, this invention relates to a tool for enabling a user to open a jar easily.

### BACKGROUND OF THE INVENTION

Prior to the conception and development of the present invention, jars and containers with lids, as are generally well known in the prior art, have been used to pack and store food. However, opening such jars and containers can be very difficult, especially for persons of limited strength such as children and elderly adults, persons with arthritis, and those suffering from hand injuries. Therefore there is a need for a device which can enable a user to open a jar or the like easily.

Specifically of interest to the present invention are the following: Buck, U.S. Pat. No. 3,751,743, discloses a device for opening five types of kitchen containers. In particular the device is for grasping the lid of a jar such that a user may turn the device and unscrew such lid.

Mikan, et al, U.S. Pat. No. 4,770,069 discloses a hand held cap opener for child resistant containers which fits over a cap of such type of container to provide a leverage means for opening such type of container.

Dickson, U.S. Pat. No. 5,209,142 discloses a container holding device for holding a container while a user removes the lid to such container.

Burns, U.S. Pat. No. 5,517,881 discloses a device for placing over a container lid which will grip such lid such that a user will be able to turn such lid and open such container using torsional force.

Mazur, U.S. Pat. No. 7,028,359 discloses a multifunctional container opener for opening a plurality of different containers. A body of the device supports a template defining one or more pockets and a pill splitting tool and one or more compartments or pockets for capturing pieces of the split pill or tablet. The body may also support a variety of tools adapted for opening a container or accessing a container's contents. Such tools include tools for piercing, scoring, cutting or prying portions of the actual container or safety seals associated with the container. The body also supports a gripping device for frictionally engaging the cap or top of a container.

None of the aforementioned references provides the benefits attendant with the present device.

### SUMMARY OF THE INVENTION

The present invention provides a seal breaking device. Such seal breaking device includes an elongated handle member having a first end and a second end. Such elongated handle member is manufactured from a first predetermined material and has a first predetermined size and a first predetermined shape. A lid lifting member is operably connected at a first end thereof to such first end of such elongated handle member. Such lid lifting member is manufactured from a second predetermined material and has a second predetermined size and a second predetermined shape.

According to another embodiment, a seal breaking device is provided which includes an elongated handle member having a first end and a second end. Such elongated handle member is manufactured from a first predetermined material and has a first predetermined size and a first predetermined shape. A lid lifting member is operably connected at a first end thereof to such first end of such elongated handle member at a predetermined angle, such lid lifting member is manufactured from a second predetermined material and has a second predetermined size and a second predetermined shape.

According to still another embodiment, a seal breaking device is provided which includes an elongated handle member having a first end and a second end. Such elongated handle member is manufactured from a first predetermined material and has a first predetermined size and a first predetermined shape. A plurality of lid lifting members, each having a first end and a second end, are releasably connectable at a first end thereof to such first end of such elongated handle member. Such plurality of lid lifting members are manufactured from a second predetermined material and have a plurality of predetermined shapes and predetermined sizes. Such second ends of such plurality of lid lifting members each have a concave portion disposed thereon and each of such concave portions has a different predetermined radius. A securing means has a first portion disposed on a first end of such elongated handle member and a second mating portion disposed on such first end of such plurality of such lid lifting members for releasably securing each of such plurality of lid lifting members to such elongated handle member.

### OBJECTS OF THE INVENTION

It is, therefore, one of the primary objects of the present invention to provide a device which can be used to break the vacuum seal on a jar, a container with a lid, or the like.

Another object of the present invention is to provide a simple lever type tool which is easy to use and which may be utilized to release a vacuum type seal on a jar, a container with a lid, or the like such that once such seal is broken such lid may be removed easily by any individual, including individuals with arthritis, an injured hand or hands, and individuals of reduced strength and ability.

Still another object of the present invention is to provide a hand held tool which may be used similarly to a lever type tool to lift the lid of a jar slightly such that air may enter such jar and the lid of such jar will then unscrew easily.

Yet another object of the present invention is to provide a device which can be used to loosen the lid of a jar without having to grip such lid such that thereafter such jar may be opened easily.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a cross-sectional view of the invention along the lines II-II of FIG. 1.

FIG. 3 is a partial perspective view of the invention according to one embodiment of the invention in which the lid lifting member is bent a predetermined angle.

FIG. 4 is a partial perspective view of the invention according to one embodiment of the invention in which a user is illustrated preparing to place the lid lifting member under the lid of the jar closely adjacent such jar such that pressure applied to such device will break such jar's vacuum type seal.

FIG. 5 is a partial perspective view of the invention according to one embodiment of such invention in which such lid lifting member is connected to such handle member at a predetermined angle.

FIG. 6 is a partial perspective view of the invention according to one embodiment of the invention in which such device includes a plurality of lid lifting members each being releasably connectable to such elongated handle member.

FIG. 7 is a partial perspective view of the invention according to one embodiment of the invention in which such device includes a plurality of lid lifting members each being releasably connectable to such elongated handle member.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

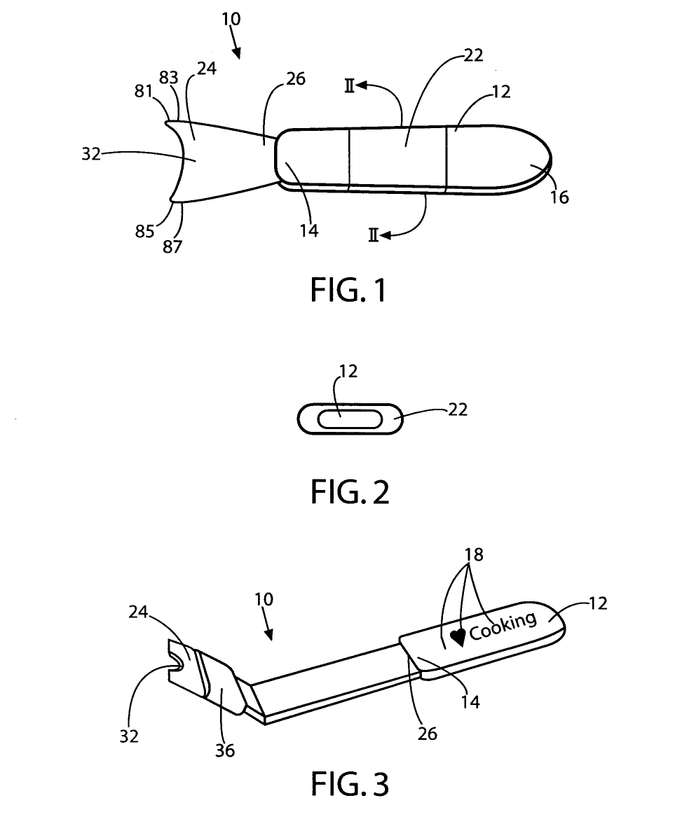

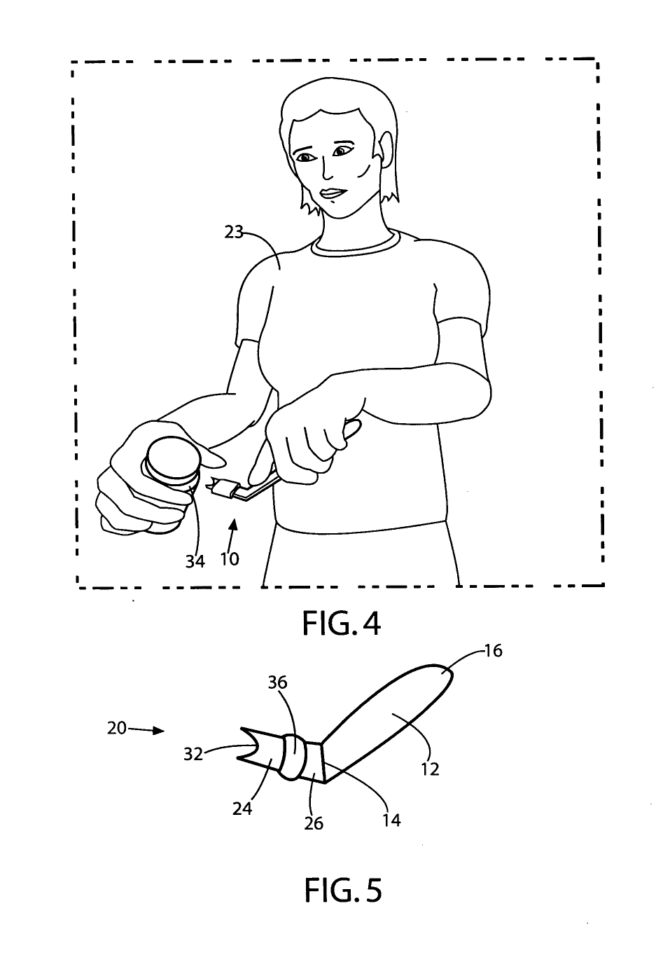

Reference is now made, more particularly, to FIGS. 1-7.

The present invention provides a seal breaking device, generally designated 10.

Such seal breaking device 10 includes an elongated handle member 12 having a first end 14 and a second end 16. Such elongated handle member 12 is manufactured from a first predetermined material and has a first predetermined size and a first predetermined shape. It is presently preferred that such first predetermined material is at least one of plastic, metal, wood, rubber, and a combination thereof. It is presently most preferred that such first predetermined material is metal. Such handle member 12 is meant to be any shape and size which is comfortable for use to a user. For example, such handle member 12 may be flat or tube shaped, however the device 10 is not meant to be limited as such and such handle member may be any shape and size reasonably suited to its purpose. It is presently preferred that such handle member has a width of between about 0.5 inches and about 1.0 inches.

It is presently preferred that such elongated handle member 12 includes indicia 18 disposed thereon illustrating predetermined information relating to predetermined subject matter. It is presently preferred that such predetermined subject matter relates to at least one of sports teams, school affiliations, business affiliations, religious affiliations, hobbies, and a combination thereof.

It is presently preferred that such elongated handle member 12 further includes a coating of rubber 22 disposed thereon, such coating of rubber 22 covering at least a predetermined portion of such elongated handle member 12.

It is meant that such device be easy to hold and apply pressure thereto by a user 23.

A lid lifting member 24 is operably connected at a first end 26 thereof to such first end 14 of such elongated handle member 12. Such lid lifting member 24 is manufactured from a second predetermined material and has a second predetermined size and a second predetermined shape. It is presently preferred that such second predetermined material is at least one of metal, plastic, and a combination thereof. It is presently preferred that such second predetermined material is metal.

It is presently preferred that such first predetermined material and such second predetermined material are substantially identical.

It is presently preferred that such lid lifting member 24 is substantially flat.

It is presently preferred that such lid lifting member 24 is bent at a predetermined angle at a predetermined location thereon, as illustrated in FIG. 3. It is presently preferred that such predetermined angle is between about 120 degrees and 140 degrees. It is presently most preferred that such predetermined angle is about 130 degrees.

It is presently preferred that such lid lifting member 24 includes a second end 32 and such second end 32 is substantially concavely formed for fitting closely adjacent a neck of a jar 34. It is presently preferred that such substantially concavely formed second end 32 includes a radius of between about 1.0 inches and 1.5 inches. It is presently preferred that such substantially concavely formed second end 32 includes a first tip 81 closely adjacent of first side end 83 of such concavely formed second end 32 and a second tip 85 closely adjacent a second side end 87 of such concavely formed second end 32 of such lid lifting member 24 and wherein such first tip 81 and such second tip 85 are at least one of rounded, squared off, and a combination thereof. Rounded style tips are depicted in FIG. 1 and squared off tips are depicted in FIG. 3.

It is presently preferred that a protective layer 36 manufactured from a third predetermined material and having a third predetermined size is disposed at least one of on and around at least a predetermined portion of such lid lifting member 24. It is presently preferred that such third predetermined material is at least one of plastic, rubber, and a combination thereof. It is presently preferred that such third predetermined material is rubber. It is meant that such protective layer may be disposed on either side of such lid lifting member 24 or even wrapped completely around such lid lifting member 24 to supply a safety feature to prevent breakage of jars and bottles in the event that such device 10 slips from a user's grasp while being implemented.

It is contemplated that such device 10 will be between about 4.5 inches and about 6.5 inches total in length, however, the device 10 is not meant to be limited as such and may be any length which reasonably facilitates its purpose.

According to another embodiment, referencing FIG. 5, a seal breaking device, generally designated 20, includes an elongated handle member 12 having a first end 14 and a second end 16. Such elongated handle member 12 is manufactured from a first predetermined material and has a first predetermined size and a first predetermined shape. A lid lifting member 24 is operably connected at a first end 26 thereof to such first end 14 of such elongated handle member 12 at a predetermined angle, such lid lifting member 24 is manufactured from a second predetermined material and has a second predetermined size and a second predetermined shape.

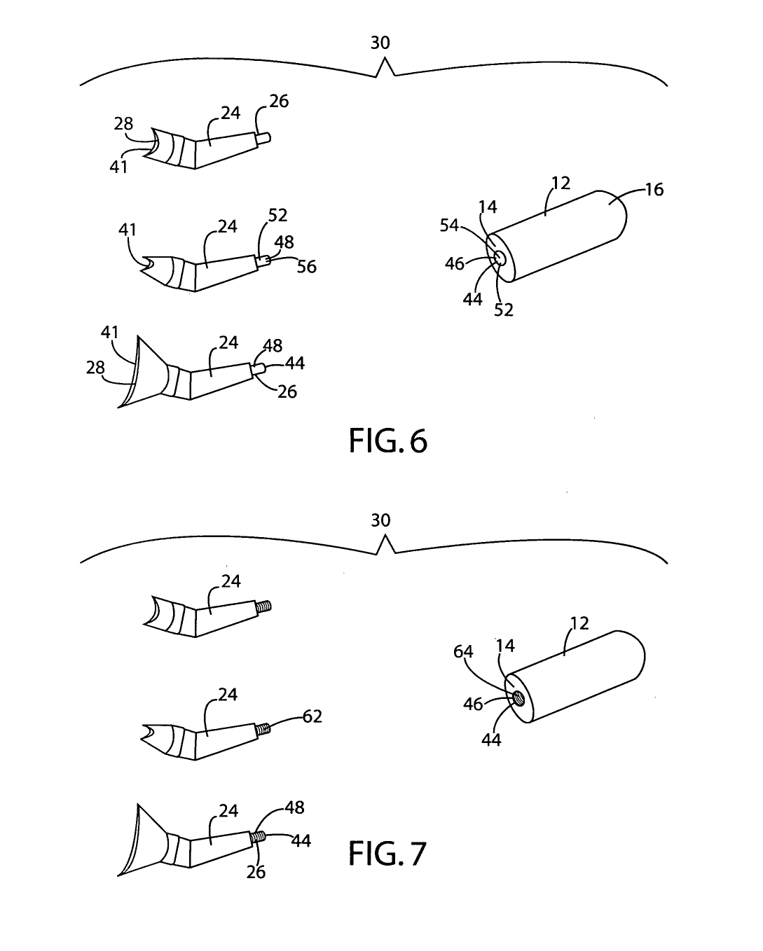

According to still another embodiment, referencing FIG. 6 and FIG. 7, a seal breaking device, generally designated 30, is provided which includes an elongated handle member 12 having a first end 14 and a second end 16. Such elongated handle member 12 is manufactured from a first predetermined material and has a first predetermined size and a first predetermined shape.

A plurality of lid lifting members 24, each having a first end 26 and a second end 28, are releasably connectable at such first end 26 thereof to such first end 14 of such elongated handle member 12. Such plurality of lid lifting members 24 are manufactured from a second predetermined material and have a plurality of predetermined shapes and predetermined sizes. Such second ends 28 of such plurality of lid lifting members 24 each have a concave portion 41 disposed thereon and each of such concave portions 41 has a different predetermined radius.

A securing means 44 has a first portion 46 disposed on such first end 14 of such elongated handle member 12 and a second mating portion 48 disposed on such first end 26 of such plurality of such lid lifting members 24 for releasably securing each of such plurality of lid lifting members 24 to such elongated handle member 12.

It is presently preferred that such securing means 44 is a friction fit securing means 52 and such first portion 46 is a first surface 54 and such second portion 48 is a second surface 56. However, the device 30 is not meant to be limited as such and any type of securing means 44 may be used which reasonably facilitates its purpose. For example, such securing means 44 may includes such first end 14 of such elongated handle member 12 having one of a threaded male portion 62 and a threaded female portion 64 and such first ends 26 of such plurality of lid lifting members 24 each having an opposite one of a threaded male portion 62 and a threaded female portion 64 such that such first ends 26 of such plurality of lid lifting members 24 can be joined to such first end 14 of such elongated handle member 12.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A seal breaking device comprising:
a. an elongated handle member manufactured from a first predetermined material and having a first predetermined size and a first predetermined shape and having a first end and a second end; and
b. a lid lifting member operably connected at a first end thereof to said first end of said elongated handle member, said lid lifting member being manufactured from a second predetermined material and having a second predetermined size and a second predetermined shape.

2. A seal breaking device according to claim 1 wherein said lid lifting member is substantially flat.

3. A seal breaking device according to claim 1 wherein said lid lifting member is bent at a predetermined angle at a predetermined location thereon.

4. A seal breaking device according to claim 3 wherein said predetermined angle is between about 120 degrees and about 140 degrees.

5. A seal breaking device according to claim 4 wherein said predetermined angle is about 130 degrees.

6. A seal breaking device according to claim 1 wherein said lid lifting member includes a second end and said second end is substantially concavely formed for fitting closely adjacent a neck of a jar.

7. A seal breaking device according to claim 6 wherein said substantially concavely formed second end 32 includes a first tip 81 closely adjacent a first side end 83 of said concavely formed second end 32 of said lid lifting member and a second tip 85 closely adjacent a second side end 87 of said concavely formed second end 32 of said lid lifting member 24 and wherein said first tip 81 and said second tip 85 are at least one of rounded, squared off, and a combination thereof.

8. A seal breaking device according to claim 1 wherein said first predetermined material is at least one of plastic, metal, wood, rubber, and a combination thereof.

9. A seal breaking device according to claim 8 wherein said first predetermined material is metal.

10. A seal breaking device according to claim 1 wherein said second predetermined material is at least one of metal, plastic, and a combination thereof.

11. A seal breaking device according to claim 10 wherein said second predetermined material is metal.

12. A seal breaking device according to claim 1 wherein said first predetermined material and said second predetermined material are substantially identical.

13. A seal breaking device according to claim 1 wherein a protective layer manufactured from a third predetermined material and having a third predetermined size is disposed at least one of on and around at least a predetermined portion of said lid lifting member.

14. A seal breaking device according to claim 13 wherein said third predetermined material is at least one of plastic, rubber, and a combination thereof.

15. A seal breaking device according to claim 1 wherein said elongated handle member includes indicia disposed thereon illustrating predetermined information relating to predetermined subject matter.

16. A seal breaking device according to claim 15 wherein said predetermined subject matter relates to at least one of sports teams, school affiliations, business affiliations, religious affiliations, hobbies, and a combination thereof.

17. A seal breaking device according to claim 1 wherein said elongated handle member further includes a coating of rubber disposed thereon, said coating of rubber covering at least a predetermined portion of said elongated handle member.

18. A seal breaking device comprising:
a. an elongated handle member having a first end and a second end, said elongated handle member being manufactured from a first predetermined material and having a first predetermined size and a first predetermined shape; and
b. a lid lifting member operably connected at a first end thereof to said first end of said elongated handle member at a predetermined angle, said lid lifting member being manufactured from a second predetermined material and having a second predetermined size and a second predetermined shape.

19. A seal breaking device comprising:
a. an elongated handle member having a first end and a second end, said elongated handle member being manufactured from a first predetermined material and having a first predetermined size and a first predetermined shape;
b. a plurality of lid lifting members each having a first end and a second end, each of said lid lifting members being releasably connectable at a first end thereof to said first end of said elongated handle member, said plurality of lid lifting members being manufactured from a second predetermined material and having a plurality of predetermined shapes and predetermined sizes, said second ends of said plurality of lid lifting members each having a concave portion disposed thereon, each of said concave portions having a different predetermined radius; and
c. a securing means having a first portion disposed on said first end of said elongated handle member and a second mating portion disposed on said first end of said plurality of said lid lifting members for releasably securing each of said plurality of lid lifting members to said elongated handle member.

20. A seal breaking device according to claim 19 wherein said securing means is a friction fit securing means and said first portion is a first surface and said second portion is a second surface.
